(19) United States
(12) Patent Application Publication
(10) Pub. No.: US 2012/0316881 A1
(43) Pub. Date: Dec. 13, 2012

(54) SPEECH SYNTHESIZER, SPEECH SYNTHESIS METHOD, AND SPEECH SYNTHESIS PROGRAM

(75) Inventor: Masanori Kato, Minato-ku (JP)

(73) Assignee: NEC CORPORATION, Tokyo (JP)

(21) Appl. No.: 13/576,406

(22) PCT Filed: Mar. 23, 2011
(86) PCT No.: PCT/JP2011/001696

§ 371 Date: Aug. 1, 2012

(30) Foreign Application Priority Data
Mar. 25, 2010 (JP) 2010-070378

(51) Int. Cl. G10L 13/08

(52) U.S. Cl. 704/260; 704/E13.011

(57) ABSTRACT

A normalized spectrum storage unit 204 prestores normalized spectra calculated based on a random number series. A voiced sound generating unit 201 generates voiced sound waveforms based on a plurality of segments of voiced sounds corresponding to an inputted text and the normalized spectra stored in the normalized spectrum storage unit 204. An unvoiced sound generating unit 202 generates unvoiced sound waveforms based on a plurality of segments of unvoiced sounds corresponding to the inputted text. A synthesized speech generating unit 203 generates a synthesized speech based on the voiced sound waveforms generated by the voiced sound generating unit 201 and the unvoiced sound waveforms generated by the unvoiced sound generating unit 202.

### TECHNICAL FIELD

The present invention relates to a speech synthesizer, a speech synthesis method and a speech synthesis program for generating a synthesized speech of an inputted text.

### BACKGROUND ART

There exist speech synthesizers analyzing a text and generating a synthesized speech by means of speech synthesis by rule based on phonetical information represented by the result of the text analysis.

Such a speech synthesizer generating a synthesized speech by means of speech synthesis by rule first generates prosodic information on the synthesized speech (information indicating prosody by the pitch of sound (pitch frequency), the length of sound (phonemic duration), magnitude of sound (power), etc.) based on the result of the analysis of the text. Subsequently, the speech synthesizer selects segments (synthesis units) corresponding to the result of the text analysis and the prosodic information from a segment dictionary which has prestored a variety of segments (waveform generation parameters).

Subsequently, the speech synthesizer generates speech waveforms based on the segments (waveform generation parameters) selected from the segment dictionary. Finally, the speech synthesizer generates the synthesized speech by connecting the generated speech waveforms.

When such a speech synthesizer generates a speech waveform based on the selected segments, the speech synthesizer generates a speech waveform having prosody approximate to that indicated by the generated prosodic information in order to generate a synthesized speech of high sound quality.

Non-patent Literature 1 describes a method for generating a speech waveform. In the method of the Non-patent Literature 1, the amplitude spectrum (as the amplitude component of the spectrum obtained by Fourier transforming the audio signal) is smoothed in the temporal frequency direction and used as the waveform generation parameters. The Non-patent Literature 1 also describes a method for calculating a normalized spectrum as the spectrum normalized by the amplitude spectrum. In this method, a group delay is calculated based on random numbers and the normalized spectrum is calculated by using the calculated group delay.

Patent Literature 1 describes a speech processing device which comprises a storage unit prestoring periodic components and nonperiodic components of speech segment waveforms to be used for the process of generating the synthesized speech.

### CITATION LIST

### Patent Literature

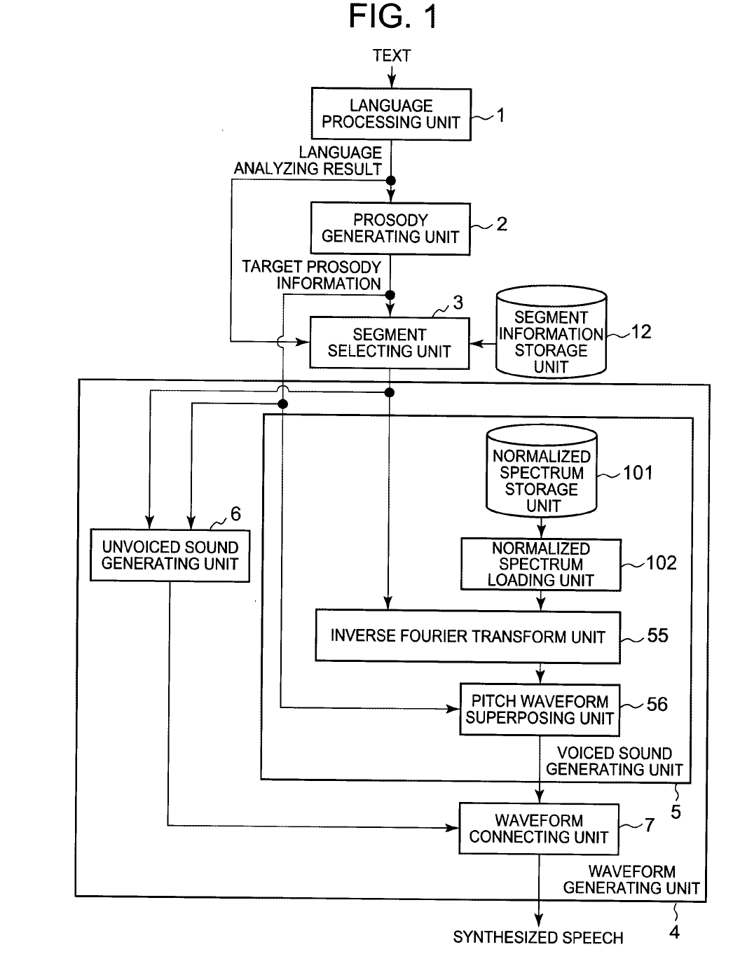

Patent Document 1: JP-A-2009-163121 (Paragraphs 0025-0289, FIG. 1)

### Non-Patent Literature

Non-patent Literature 1: Hideki Kawahara, “Speech Representation and Transformation Using Adaptive Interpolation of Weighted Spectrum: Vocoder Revisited”, (USA), IEEE ICASSP-97, Vol. 2, 1997, p. 1303-1306

### SUMMARY OF INVENTION

### Technical Problem

In the waveform generation method employed by the aforementioned speech synthesizer, the normalized spectrum is calculated successively. The normalized spectrum is used for generating a pitch waveform which has to be generated at intervals of approximately the pitch period. Therefore, the speech synthesizer employing the waveform generation method has to calculate the normalized spectrum with great frequency, resulting in an extremely large number of calculations.

Further, the calculation of the normalized spectrum requires the calculation of the group delay based on random numbers as described in the Non-patent Literature 1. In the process of calculating the normalized spectrum by using the group delay, an integral computation including a great number of calculations has to be carried out. Thus, the speech synthesizer employing the above waveform generation method has to execute the sequence of calculations (the calculation of the group delay based on random numbers and the calculation of the normalized spectrum from the calculated group delay by conducting the integral computation including a great number of calculations) with great frequency.

With the increase in the number of calculations, the throughput (workload per unit time) required of the speech synthesizer for generating the synthesized speech increases. Therefore, the generation of the synthesized speech that should be outputted every unit time can become impossible especially when a speech synthesizer of low processing power outputs the synthesized speech in sync with the generation of the synthesized speech. The impossibility of smoothly outputting the synthesized speech seriously affects the sound quality of the synthesized speech outputted by the speech synthesizer.

Meanwhile, the speech processing device described in the Patent Literature 1 generates the synthesized speech by using the periodic components and nonperiodic components of speech segment waveforms prestored in the storage unit. Such speech processing devices are being required to generate synthesized speeches of higher sound quality.

It is therefore the primary object of the present invention to provide a speech synthesizer, a speech synthesis method and a speech synthesis program that make it possible to generate synthesized speeches of higher sound quality with a smaller number of calculations.

### Solution to Problem

In order to achieve the above object, the present invention provides a speech synthesizer which generates a synthesized speech of an inputted text, comprising: a voiced sound generating unit which includes a normalized spectrum storage unit prestoring one or more normalized spectra calculated based on a random number series and generates voiced sound waveforms based on a plurality of segments of voiced sounds corresponding to the text and the normalized spectra stored in the normalized spectrum storage unit; an unvoiced sound generating unit which generates unvoiced sound waveforms based on a plurality of segments of unvoiced sounds corresponding to the text; and a synthesized speech generating unit which generates the synthesized speech based on the voiced sound waveforms generated by the voiced sound generating unit and the unvoiced sound waveforms generated by the unvoiced sound generating unit.

The present invention also provides a speech synthesis method for generating a synthesized speech of an inputted text, comprising: generating voiced sound waveforms based on a plurality of segments of voiced sounds corresponding to the text and one or more normalized spectra stored in a normalized spectrum storage unit prestoring the normalized spectra calculated based on a random number series; generating unvoiced sound waveforms based on a plurality of segments of unvoiced sounds corresponding to the text; and generating the synthesized speech based on the generated voiced sound waveforms and the generated unvoiced sound waveforms.

The present invention also provides a speech synthesis program to be installed in a speech synthesizer which generates a synthesized speech of an inputted text, wherein the speech synthesis program causes a computer to execute: a voiced sound waveform generating process of generating voiced sound waveforms based on a plurality of segments of voiced sounds corresponding to the text and one or more normalized spectra stored in a normalized spectrum storage unit prestoring the normalized spectra calculated based on a random number series; an unvoiced sound waveform generating process of generating unvoiced sound waveforms based on a plurality of segments of unvoiced sounds corresponding to the text; and a synthesized speech generating process of generating the synthesized speech based on the voiced sound waveforms generated in the voiced sound waveform generating process and the unvoiced sound waveforms generated in the unvoiced sound waveform generating process.

### ADVANTAGEOUS EFFECT OF THE INVENTION

According to the present invention, the waveform of the synthesized speech is generated by using the normalized spectra prestored in the normalized spectrum storage unit. Thus, the calculation of the normalized spectra can be left out at the time of generating the synthesized speech. Consequently, the number of calculations necessary at the time of speech synthesis can be reduced.

Further, since the normalized spectra are used for generating the synthesized speech waveforms, synthesized speeches of higher sound quality can be generated compared to the case where the periodic components and nonperiodic components of speech segment waveforms are used for generating the synthesized speech.

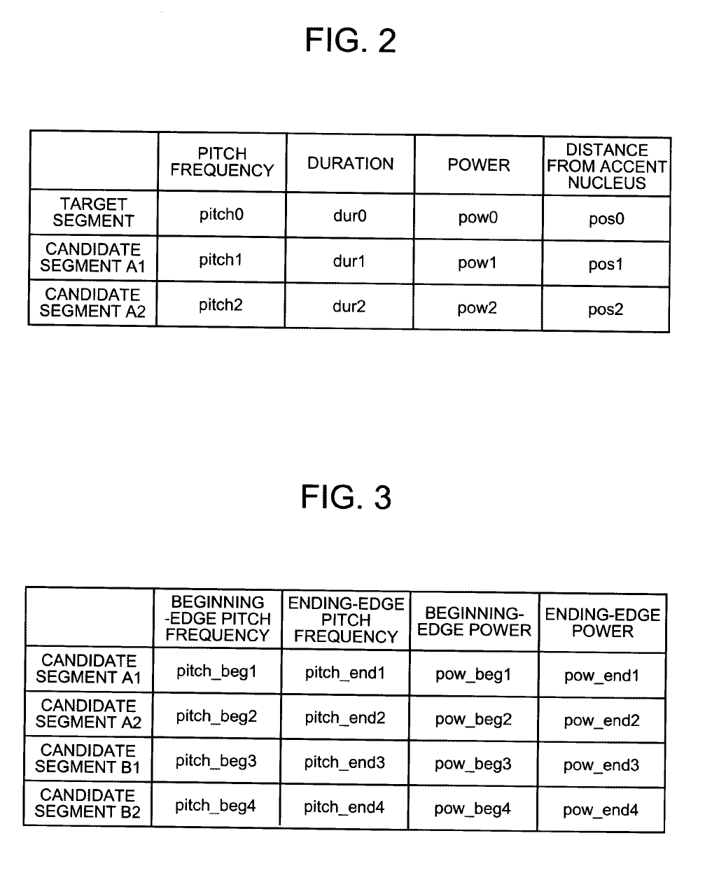

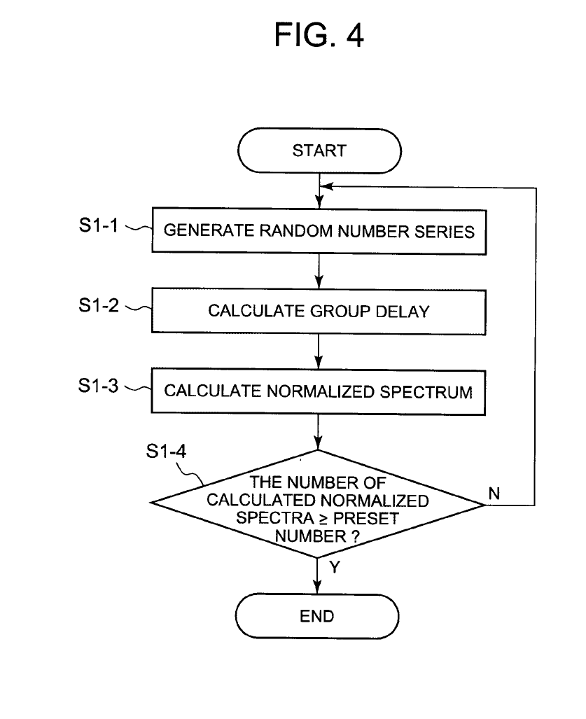

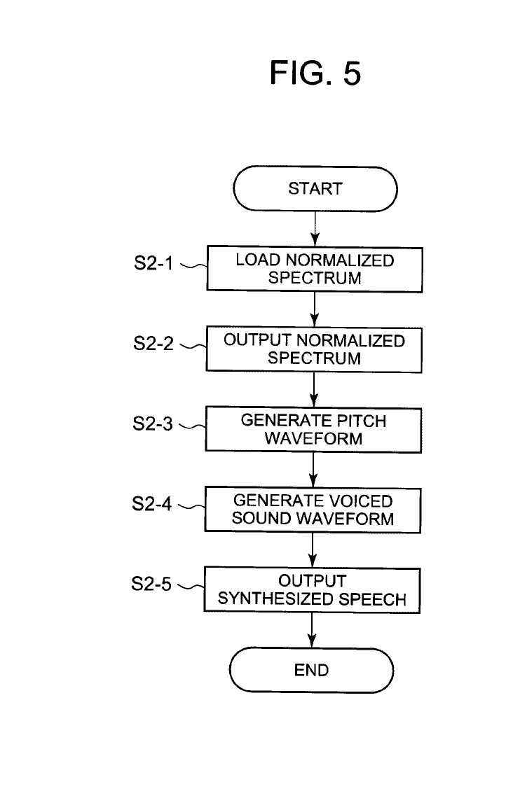

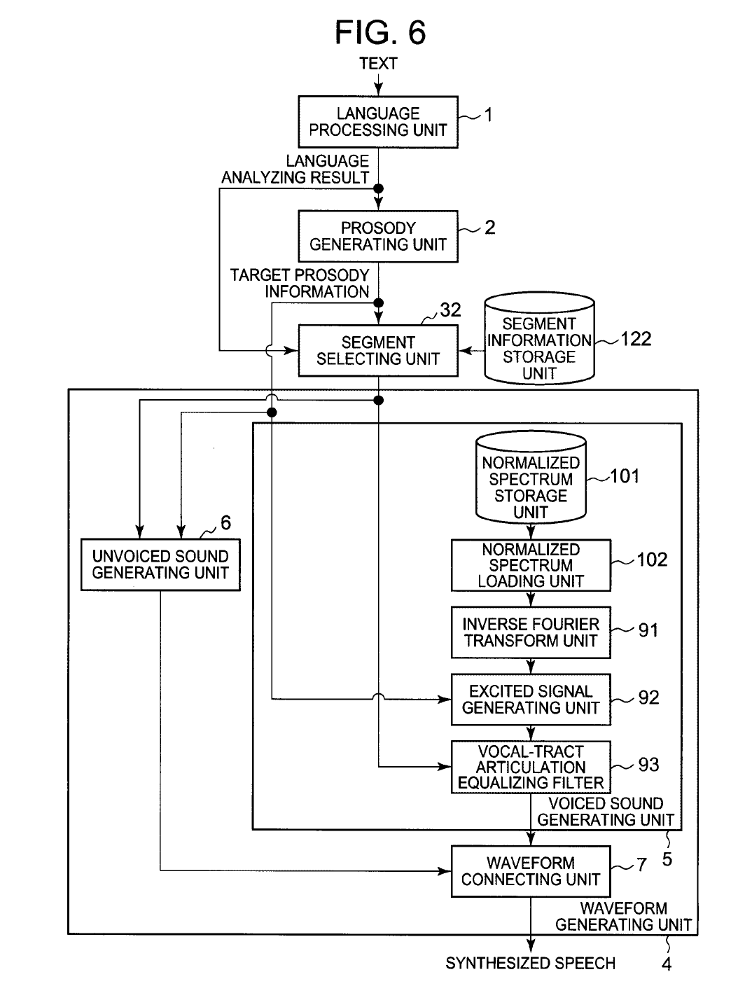

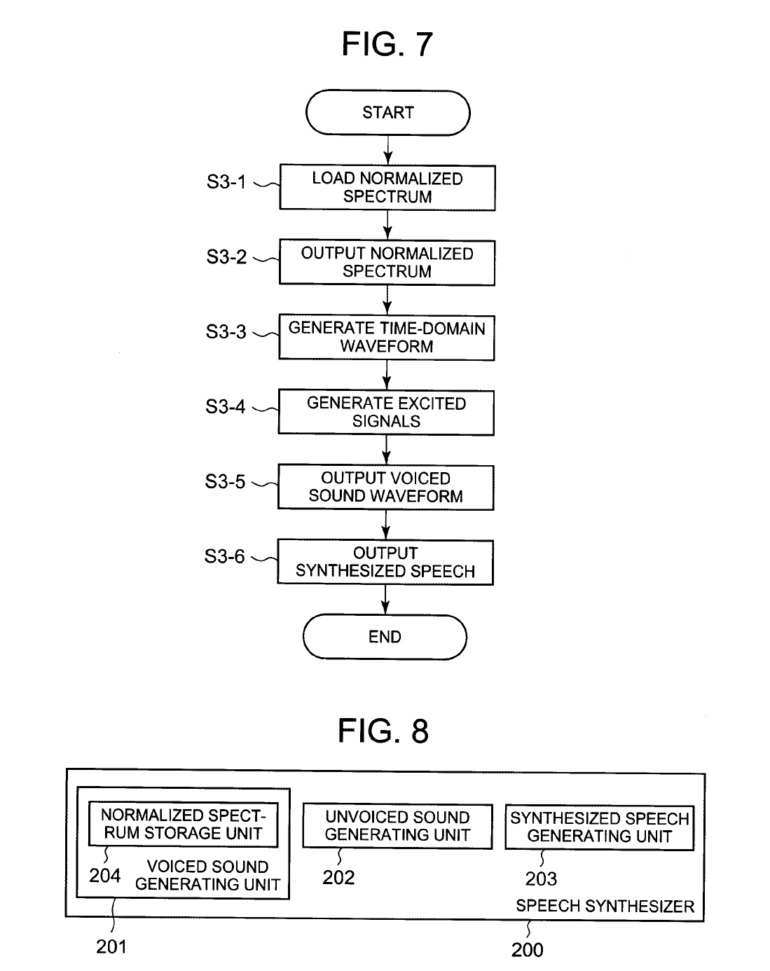

### BRIEF DESCRIPTION OF DRAWINGS

[FIG. 1] It depicts a block diagram showing an example of the configuration of a speech synthesizer in accordance with a first exemplary embodiment of the present invention.

[FIG. 2] It depicts a table showing each piece of information indicated by target segment environment and each piece of information indicated by attribute information on candidate segments A1 and A2.

[FIG. 3] It depicts a table showing each piece of information indicated by the attribute information on candidate segments A1, A2, B1 and B2.

[FIG. 4] It depicts a flow chart showing a process for calculating normalized spectra to be stored in a normalized spectrum storage unit.

[FIG. 5] It depicts a flow chart showing the operation of a waveform generating unit of the speech synthesizer in the first exemplary embodiment.

[FIG. 6] It depicts a block diagram showing an example of the configuration of a speech synthesizer in accordance with a second exemplary embodiment of the present invention.

[FIG. 7] It depicts a flow chart showing the operation of a waveform generating unit of the speech synthesizer in the second exemplary embodiment.

[FIG. 8] It depicts a block diagram showing the principal part of the speech synthesizer in accordance with the present invention.

### DESCRIPTION OF EMBODIMENTS

### First Exemplary Embodiment

A first exemplary embodiment of a speech synthesizer in accordance with the present invention will be described below with reference to figures. FIG. 1 is a block diagram showing an example of the configuration of the speech synthesizer in accordance with the first exemplary embodiment of the present invention.

As shown in FIG. 1, the speech synthesizer in accordance with the first exemplary embodiment of the present invention comprises a waveform generating unit 4. The waveform generating unit 4 includes a voiced sound generating unit 5, an unvoiced sound generating unit 6 and a waveform connecting unit 7. The waveform generating unit 4 is connected to a language processing unit 1 via a segment selecting unit 3 and a prosody generating unit 2 as shown in FIG. 1. A segment information storage unit 12 is connected to the segment selecting unit 3.

The voiced sound generating unit 5 includes a normalized spectrum storage unit 101, a normalized spectrum loading unit 102, an inverse Fourier transform unit 55 and a pitch waveform superposing unit 56 as shown in FIG. 1.

The segment information storage unit 12 has stored segments (speech segments) which have been generated for speech synthesis units, respectively, and attribute information on each segment. The segment is, for example, a speech waveform which has been segmented (cut out, extracted) for each speech synthesis unit, a time series of waveform generation parameters (linear prediction analysis parameters, cepstrum coefficients, etc.) extracted from the segmented speech waveform, or the like. The following explanation will be given by taking an example of a case where the segments of voiced sounds are amplitude spectra and the segments of unvoiced sounds are segmented (cut out, extracted) speech waveforms.

The attribute information on a segment includes phonological information (indicating the phoneme environment, pitch frequency, amplitude, duration, etc. of the sound (voice) as the basis of each segment) and prosodic information. The segments are in many cases extracted or generated from voice (natural speech waveform) uttered by a human. For example, the segments are sometimes extracted or generated from recorded sound data of voice uttered by an announcer or voice actor/actress.

The human (speaker) who uttered the voice as the basis of the segments is called “the original speaker” of the segments. A phoneme, a syllable, a demisyllable (e.g., CV (C: consonant, V: vowel)), CVC, VCV, etc. are generally used as the speech synthesis unit.

The following Reference Literatures 1 and 2 include explanations of the synthesis unit and the length of the segment.

Reference Literature 1: Huang, Acero, Hon, “Spoken Language Processing,” Prentice Hall, 2001, p.689-836

Reference Literature 2: Masanobu Abe, et al., “An Introduction to Speech Synthesis Units,” IEICE (the Institute of Electronics, Information and Communication Engineers (Japan)) Technical Report, Vol. 100, No. 392, 2000, p. 35-42

The language processing unit 1 analyzes texts of an inputted text. Specifically, the language processing unit 1 executes analysis such as morphological analysis, parsing or reading analysis. Based on the result of the analysis, the language processing unit 1 outputs information indicating a symbol string representing the “reading” (e.g., phonemic symbols) and information indicating the part of speech, conjugation, accent type, etc. of each morpheme to the prosody generating unit 2 and the segment selecting unit 3 as a language analyzing result.

The prosody generating unit 2 generates prosody of the synthesized speech based on the language analyzing result outputted by the language processing unit 1. The prosody generating unit 2 outputs prosodic information indicating the generated prosody to the segment selecting unit 3 and the waveform generating unit 4 as target prosody information (target prosodic information). The prosody is generated by a method described in the following Reference Literature 3, for example:

Reference Literature 3: Yasushi Ishikawa, “Prosodic Control for Japanese Text-to-Speech Synthesis,” IEICE (The Institute of Electronics, Information and Communication Engineers (Japan)) Technical Report, Vol. 100, No. 392, 2000, p. 27-34

The segment selecting unit 3 selects segments satisfying prescribed conditions from the segments stored in the segment information storage unit 12 based on the language analyzing result and the target prosody information. The segment selecting unit 3 outputs the selected segments and attribute information on the segments to the waveform generating unit 4.

The operation of the segment selecting unit 3 for selecting the segments satisfying the prescribed conditions from the segments stored in the segment information storage unit 12 will be explained below. Based on the inputted language analyzing result and target prosody information, the segment selecting unit 3 generates information indicating characteristics of the synthesized speech (hereinafter referred to as “target segment environment”) for each speech synthesis unit.

The target segment environment is information including a concerned phoneme (constituting the synthesized speech as the target of the generation of the target segment environment), a preceding phoneme (as the phoneme before the concerned phoneme), a succeeding phoneme (as the phoneme after the concerned phoneme), the presence/absence of a stress, the distance from the accent nucleus, the pitch frequency of each speech synthesis unit, the power, the duration of each speech synthesis unit, the cepstrum, the MFCC (Mel Frequency Cepstral Coefficients), the A amounts (variations per unit time) of these values, etc.

Subsequently, for each speech synthesis unit, the segment selecting unit 3 acquires a plurality of segments corresponding to consecutive phonemes from the segment information storage unit 12 based on the information included in the generated target segment environment. Specifically, the segment selecting unit 3 acquires a plurality of segments corresponding to the concerned phoneme, a plurality of segments corresponding to the preceding phoneme, and a plurality of segments corresponding to the succeeding phoneme from the segment information storage unit 12 based on the information included in the target segment environment. The acquired segments are candidates of the segments used for generating the synthesized speech (hereinafter referred to as “candidate segments”).

Then, for each combination of adjacent candidate segments (e.g., a candidate segment corresponding to the concerned phoneme and a candidate segment corresponding to the preceding phoneme), the segment selecting unit 3 calculates a “cost” as an index representing the degree of suitability of the combination as segments used for generating the voice (speech). The cost is a result of calculation of the difference between the target segment environment and the attribute information on each candidate segment and the difference in the attribute information between the adjacent candidate segments.

The cost (the value of the calculation result) decreases with the increase in the similarity between the characteristics of the synthesized speech (represented by the target segment environment) and the candidate segments, that is, with the increase in the degree of suitability of the combination for generating the voice (speech). With the decrease in the cost of the segments that are used, naturalness of the synthesized speech (synthesized speech), indicating the degree of similarity to a speech uttered by a human, increases. The segment selecting unit 3 selects a segment whose calculated cost is the lowest.

Specifically, the cost calculated by the segment selecting unit 3 includes a unit cost and a connection cost. The unit cost indicates the degree of sound quality deterioration that is presumed to occur when the candidate segment is used in an environment represented by the target segment environment. The unit cost is calculated based on the degree of similarity between the attribute information on the candidate segment and the target segment environment.

The connection cost indicates the degree of sound quality deterioration that is presumed to occur due to discontinuity of the segment environment between the connected speech segments. The connection cost is calculated based on the affinity of the segment environment between the adjacent candidate segments. There have been proposed various methods for the calculation of the unit cost and the connection cost.

In general, the unit cost is calculated by using information included in the target segment environment. The connection cost is calculated by using the pitch frequency at the connection boundary of the adjacent segments, the cepstrum, the MFCC, the short-term autocorrelation, the power, the A amounts of these values, etc. Specifically, the unit cost and the connection cost are calculated by using multiple pieces of information selected from the variety of information on the segments (pitch frequency, cepstrum, power, etc.).

An example of the calculation of the unit cost will be explained below. FIG. 2 is a table showing each piece of information indicated by the target segment environment and each piece of information indicated by the attribute information on candidate segments A1 and A2.

In the example shown in FIG. 2, the pitch frequency indicated by the target segment environment is pitch0 [Hz]. The duration indicated by the target segment environment is dur0 [sec]. The power indicated by the target segment environment is pow0 [dB]. The distance from the accent nucleus indicated by the target segment environment is pos0. The pitch frequency indicated by the attribute information on the candidate segment A1 is pitch1 [Hz]. The duration indicated by the attribute information on the candidate segment A1 is dur1 [sec]. The power indicated by the attribute information on the candidate segment A1 is pow1 [dB]. The distance from the accent nucleus indicated by the attribute information on the candidate segment A1 is post. Similarly, the pitch frequency, the duration, the power and the distance from the accent nucleus indicated by the attribute information on the candidate segment A2 are pitch2 [Hz], dur2 [sec], pow2 [dB] and pos2.

Incidentally, the “distance from the accent nucleus” means the distance from a phoneme as the accent nucleus in the speech synthesis unit. For example, when the third phoneme is the accent nucleus in a speech synthesis unit composed of five phonemes, the “distance from the accent nucleus” of a segment corresponding to the first phoneme is “−2”. The “distance from the accent nucleus” of a segment corresponding to the second phoneme is “−1”. The “distance from the accent nucleus” of a segment corresponding to the third phoneme is “0”. The “distance from the accent nucleus” of a segment corresponding to the fourth phoneme is “+1”. The “distance from the accent nucleus” of a segment corresponding to the fifth phoneme is “+2”.

The formula for calculating the unit cost (unit_score(A1)) of the candidate segment A1 is:
unit_score(A1)=(w1×(pitch0−pitch1)̂2)
   +(w2×(dur0−dur1)̂)
   +(w3×(pow0−pow1)̂)
   +(w4×(pos0−pos1)̂)

The formula for calculating the unit cost (unit_score(A2)) of the candidate segment A2 is:
unit_score(A2)=(w1×(pitch0−pitch2)̂)
   +(w2×(dur0−dur2)̂)
   +(w3×(pow0−pow2)̂)
   +(w4×(pos0−pos2)̂)

In the above formulas, w1-w4 represent preset weighting factors. The symbol “A” represents a power. For example, “2̂2” represents the second power of 2.

An example of the calculation of the connection cost will be explained below. FIG. 3 is a table showing each piece of information indicated by the attribute information on candidate segments A1, A2, B1 and B2. Incidentally, the candidate segments B1 and B2 are candidate segments for a segment succeeding the segment having the candidate segments A1 and A2 as its candidate segments.

In the example shown in FIG. 3, the beginning-edge pitch frequency of the candidate segment A1 is pitch_beg1 [Hz], the ending-edge pitch frequency of the candidate segment A1 is pitch_end1 [Hz], the beginning-edge power of the candidate segment A1 is pow_beg1 [dB], and the ending-edge power of the candidate segment A1 is pow_end1 [dB]. The beginning-edge pitch frequency of the candidate segment A2 is pitch_beg2 [Hz], the ending-edge pitch frequency of the candidate segment A2 is pitch_end2 [Hz], the beginning-edge power of the candidate segment A2 is pow_beg2 [dB], and the ending-edge power of the candidate segment A2 is pow_end2 [dB].

Similarly, the beginning-edge pitch frequency, the ending-edge pitch frequency, the beginning-edge power and the ending-edge power of the candidate segment B1 are pitch_beg3 [Hz], pitch_end3 [Hz], pow_beg3 [dB] and pow_end3 [dB], and those of the candidate segment B2 are pitch_beg4 [Hz], pitch_end4 [Hz], pow_beg4 [dB] and pow_end4 [dB].

The formula for calculating the connection cost (concat_score(A1, B1)) of the candidate segments A1 and B1 is:

concat_score(A1, B1)=(c1×(pitch_end1−pitch_beg3)̂2) +(c2×(pow_end1−pow_beg3)̂2)

The formula for calculating the connection cost (concat_score(A1, B2)) of the candidate segments A1 and B2 is:

concat_score(A1, B2)=(c1×(pitch_end1−pitch_beg4)̂2) +(c2×(pow_end1−pow_beg4)̂2)

The formula for calculating the connection cost (concat_score(A2, B1)) of the candidate segments A2 and B1 is:

concat_score(A2, B1)=(c1×(pitch_end2−pitch_beg3)̂2) +(c2×(pow_end2−pow_beg3)̂2)

The formula for calculating the connection cost (concat_score(A2, B2)) of the candidate segments A2 and B2 is:

concat_score(A2, B2)=(c1×(pitch_end2−pitch_beg4)̂2) +(c2×(pow_end2−pow_beg4)̂2)

In the above formulas, c1 and c2 represent preset weighting factors.

Based on the calculated unit costs and connection costs, the segment selecting unit 3 calculates the cost of the combination of the candidate segments A1 and B1. Specifically, the cost of the combination of the candidate segments A1 and B1 is calculated as unit(A1)+unit(B1)+concat_score(A1, B1). Meanwhile, the cost of the combination of the candidate segments A2 and B1 is calculated as unit(A2)+unit(B1)+concat_score(A2, B1).

Similarly, the cost of the combination of the candidate segments A1 and B2 is calculated as unit(A1)+unit(B2)+concat_score(A1, B2), and the cost of the combination of the candidate segments A2 and B2 is calculated as unit(A2)+unit(B2)+concat_score(A2, B2).

The segment selecting unit 3 selects a combination of segments minimizing the calculated cost from the candidate segments, as segments most suitable for the synthesis of the voice (speech). The segments selected by the segment selecting unit 3 will hereinafter be referred to as “selected segments”.

The waveform generating unit 4 generates speech waveforms having prosody coinciding with or similar to the target prosody information based on the target prosody information outputted by the prosody generating unit 2, the segments outputted by the segment selecting unit 3 and the attribute information on the segments. The waveform generating unit 4 generates the synthesized speech by connecting the generated speech waveforms. The speech waveforms generated by the waveform generating unit 4 from the segments will hereinafter be referred to as “segment waveforms” in order to discriminate them from ordinary speech waveforms.

The segments outputted by the segment selecting unit 3 can be classified into those made up of voiced sounds and those made up of unvoiced sounds. The method employed for the prosodic control for voiced sounds and the method employed for the prosodic control for unvoiced sounds differ from each other. The waveform generating unit 4 includes the voiced sound generating unit 5, the unvoiced sound generating unit 6, and the waveform connecting unit 7 for connecting voiced sounds and unvoiced sounds. The segment selecting unit 3 outputs segments of voiced sounds (voiced sound segments) to the voiced sound generating unit 5, while outputting segments of unvoiced sounds (unvoiced sound segments) to the unvoiced sound generating unit 6. The prosodic information outputted by the prosody generating unit 2 is inputted to both the voiced sound generating unit 5 and the unvoiced sound generating unit 6.

Based on the segments of unvoiced sounds outputted by the segment selecting unit 3, the unvoiced sound generating unit 6 generates an unvoiced sound waveform having prosody coinciding with or similar to the prosodic information outputted by the prosody generating unit 2. In this example, the segments of unvoiced sounds outputted by the segment selecting unit 3 are the segmented (cut out, extracted) speech waveforms. Therefore, the unvoiced sound generating unit 6 is capable of generating the unvoiced sound waveform by using a method described in the following Reference Literature 4: Alternatively, the unvoiced sound generating unit 6 may also generate the unvoiced sound waveform by using a method described in the following Reference Literature 5:

Reference Literature 4: Ryuji Suzuki, Masayuki Misaki, “Time-scale Modification of Speech Signals Using Cross-correlation, ” (USA), IEEE Transactions on Consumer Electronics, Vol. 38, 1992, p. 357-363

Reference Literature 5: Nobumasa Seiyama, et al., “Development of a High-quality Real-time Speech Rate Conversion System,” The Transactions of the Institute of Electronics, Information and Communication Engineers (Japan), Vol. J84-D-2, No. 6, 2001, p. 918-926

The voiced sound generating unit 5 includes the normalized spectrum storage unit 101, the normalized spectrum loading unit 102, the inverse Fourier transform unit 55 and the pitch waveform superposing unit 56.

Here, an explanation will be given of the spectrum, the amplitude spectrum and the normalized spectrum. The spectrum is defined by a Fourier transform of a certain signal. A detailed explanation of the spectrum and the Fourier transform has been given in the following Reference Literature 6:

Reference Literature 6: Shuzo Saito, Kazuo Nakata, “Basics of Phonetical Information Processing”, Ohmsha, Ltd., 1981, p. 15-31, 73-76

As described in the Reference Literature 6, each spectrum is expressed by a complex number, and the amplitude component of the spectrum is called an “amplitude spectrum”. In this example, the result of normalization of a spectrum by using its amplitude spectrum is called a “normalized spectrum”. When a spectrum is expressed as X(w), the amplitude spectrum and the normalized spectrum can be expressed mathematically as |X(w)| and X(w)/|X(w)|, respectively.

The normalized spectrum storage unit 101 stores normalized spectra which have been calculated previously. FIG. 4 is a flow chart showing a process for calculating the normalized spectra to be stored in the normalized spectrum storage unit 101.

As shown in FIG. 4, a series of random numbers is generated first (step S1-1). Based on the generated series of random numbers, the group delay of the phase component of the spectrum is calculated by the method described in the Non-patent Literature 1 (step S1-2). Definitions of the phase component of a spectrum and the group delay of the phase component have been described in the following Reference Literature 7:

Reference Literature 7: Hideki Banno, et al., “Speech Manipulation Method Using Phase Manipulation Based on Time-Domain Smoothed Group Delay,” The Transactions of the Institute of Electronics, Information and Communication Engineers (Japan), Vol. J83-D-2, No. 11, 2000, p. 2276-2282

Subsequently, the normalized spectrum is calculated by using the calculated group delay (step S1-3). A method for calculating the normalized spectrum by using the group delay is described in the Reference Literature 7. Finally, whether the number of the calculated normalized spectra has reached a preset number (set value) or not is checked (step S1-4). If the number of the calculated normalized spectra has reached the preset number, the process is ended, otherwise the process returns to the step S1-1.

The preset number (set value) used for the check in the step S1-4 equals the number of normalized spectra stored in the normalized spectrum storage unit 101. It is desirable that the normalized spectra to be stored in the normalized spectrum storage unit 101 be generated based on a series of random numbers and a large number of normalized spectra be generated and stored in order to secure high randomness. However, the normalized spectrum storage unit 101 is required to have a high storage capacity corresponding to number of the normalized spectra. Thus, the set value (preset number) used for the check in the step S1-4 is desired to be set at a maximum value corresponding to a maximum storage capacity permissible in the speech synthesizer. Specifically, it is enough from the viewpoint of sound quality if approximately one million normalized spectra, at most, are stored in the normalized spectrum storage unit 101.

Further, the number of normalized spectra stored in the normalized spectrum storage unit 101 should be two or more. If the number is one, that is, if only one normalized spectrum has been stored in the normalized spectrum storage unit 101, only one type of normalized spectrum is loaded by the normalized spectrum loading unit 102, that is, the same normalized spectrum is loaded every time. In this case, the phase component of the spectrum of the generated synthesized speech becomes always constant and the constant phase component causes deterioration in the sound quality. For this reason, the normalized spectrum storage unit 101 should store two or more normalized spectra.

As explained above, the number of normalized spectra stored in the normalized spectrum storage unit 101 should be set within a range from 2 to a million. The normalized spectra stored in the normalized spectrum storage unit 101 are desired to be as different from each other as possible for the following reason: In cases where the normalized spectrum loading unit 102 loads the normalized spectra from the normalized spectrum storage unit 101 in a random order, the probability of consecutive loading of identical normalized spectra by the normalized spectrum loading unit 102 increases with the increase in the number of identical normalized spectra stored in the normalized spectrum storage unit 101.

The ratio (percentage) of the identical normalized spectra among all the normalized spectra stored in the normalized spectrum storage unit 101 is desired to be less than 10%. If identical normalized spectra are consecutively loaded by the normalized spectrum loading unit 102, the sound quality deterioration due to the constant phase component occurs as mentioned above.

In the normalized spectrum storage unit 101, the normalized spectra, each of which was generated based on a series of random numbers, have been stored in a random order. In order to prevent the normalized spectrum loading unit 102 from consecutively loading identical normalized spectra in the loading of the normalized spectra, the data inside the normalized spectrum storage unit 101 are desired to be arranged to avoid storage of identical normalized spectra at consecutive positions. With such a configuration, the consecutive loading of two or more identical normalized spectra can be prevented when the successive loading (sequential read) of normalized spectra is conducted by the normalized spectrum loading unit 102.

Further, in order to prevent the consecutive use of two or more identical normalized spectra when the random loading (random read) of normalized spectra is conducted by the normalized spectrum loading unit 102, the speech synthesizer is desired to be configure as below. The normalized spectrum loading unit 102 includes storage means for storing the normalized spectrum which has been loaded. The normalized spectrum loading unit 102 judges whether or not the normalized spectrum loaded in the current process is identical with the normalized spectrum that has been loaded and stored in the storage means in the previous process. When the normalized spectrum loaded in the current process is not identical with the normalized spectrum loaded and stored in the storage means in the previous process, the normalized spectrum loading unit 102 updates the normalized spectrum stored in the storage means with the normalized spectrum loaded in the current process. In contrast, when the normalized spectrum loaded in the current process is identical with the normalized spectrum loaded and stored in the storage means in the previous process, the normalized spectrum loading unit 102 repeats the process of loading a normalized spectrum until a normalized spectrum not identical with the normalized spectrum loaded and stored in the storage means in the previous process is loaded.

The operation of the waveform generating unit 4 of the speech synthesizer in accordance with the first exemplary embodiment will be explained below with reference to figures. FIG. 5 is a flow chart showing the operation of the waveform generating unit 4 of the speech synthesizer in the first exemplary embodiment.

The normalized spectrum loading unit 102 loads a normalized spectrum stored in the normalized spectrum storage unit 101 (step S2-1). Subsequently, the normalized spectrum loading unit 102 outputs the loaded normalized spectrum to the inverse Fourier transform unit 55 (step S2-2).

In the step S2-1, the randomness increases if the normalized spectrum loading unit 102 loads the normalized spectra in a random order rather than conducting the loading successively from the front end (first address) of the normalized spectrum storage unit 101 (e.g., in order of the address in the storage area). Thus, the sound quality can be improved by making the normalized spectrum loading unit 102 load the normalized spectra in a random order. This is especially effective when the number of normalized spectra stored in the normalized spectrum storage unit 101 is small.

The inverse Fourier transform unit 55 generates a pitch waveform, as a speech waveform having a length approximately equal to the pitch period, based on the segments supplied from the segment selecting unit 3 and the normalized spectrum supplied from the normalized spectrum loading unit 102 (step S2-3). The inverse Fourier transform unit 55 outputs the generated pitch waveform to the pitch waveform superposing unit 56.

Incidentally, the segments of voiced sounds (voiced sound segments) outputted by the segment selecting unit 3 are assumed to be amplitude spectra in this example. Therefore, the inverse Fourier transform unit 55 first calculates a spectrum by obtaining the product of the amplitude spectrum and the normalized spectrum. Subsequently, the inverse Fourier transform unit 55 generates the pitch waveform (as a time-domain signal and a speech waveform) by calculating the inverse Fourier transform of the calculated spectrum.

The pitch waveform superposing unit 56 generates a voiced sound waveform having prosody coinciding with or similar to the prosodic information outputted by the prosody generating unit 2 by connecting a plurality of pitch waveforms outputted by the inverse Fourier transform unit 55 while superposing them (step S2-4). For example, the pitch waveform superposing unit 56 superposes the pitch waveforms and generates the waveform by employing a method described in the following Reference Literature 8:

Reference Literature 8: Eric Moulines, Francis Charpentier, “Pitch-synchronous Waveform Processing Techniques for Text-to-speech Synthesis Using Diphones,” (Netherlands), Elsevier Science Publishers B.V., Speech Communication, Vol. 9, 1990, p. 453-467

The waveform connecting unit 7 outputs the waveform of a synthesized speech by connecting the voiced sound waveform generated by the pitch waveform superposing unit 56 and the unvoiced sound waveform generated by the unvoiced sound generating unit 6 (step S2-5).

Specifically, let v(t) (t=1, 2, 3, . . . , t_v) represent the voiced sound waveform generated by the pitch waveform superposing unit 56 and u(t) (t=1, 2, 3, . . . , t_u) represent the unvoiced sound waveform generated by the unvoiced sound generating unit 6, the waveform connecting unit 7 may generate and output the following synthesized speech waveform x(t), for example, by connecting the voiced sound waveform v(t) and the unvoiced sound waveform u(t):

x(t)=v(t) when t=1, . . . , t_{—}v

x(t)=u(t−t_{—}v) when t=(t_{—}v+1), . . . , (t_{—}v+t_{—}u)

In this exemplary embodiment, the waveform of the synthesized speech is generated and outputted by use of the normalized spectra which have previously been calculated and stored in the normalized spectrum storage unit 101. Therefore, the calculation of the normalized spectra can be left out at the time of generating the synthesized speech. Consequently, the number of calculations necessary at the time of speech synthesis can be reduced.

Further, since normalized spectra are used for generating the synthesized speech waveforms, synthesized speeches of higher sound quality can be generated compared to the case where the periodic components and nonperiodic components of speech segment waveforms are used for generating the synthesized speech as in the device described in the Patent Literature 1.

### Second Exemplary Embodiment

A second exemplary embodiment of the speech synthesizer in accordance with the present invention will be described below with reference to figures. The speech synthesizer of this exemplary embodiment generates the synthesized speech by a method different from that employed in the first exemplary embodiment. FIG. 6 is a block diagram showing an example of the configuration of the speech synthesizer in accordance with the second exemplary embodiment of the present invention.

As shown in FIG. 6, the speech synthesizer in accordance with the second exemplary embodiment of the present invention comprises an inverse Fourier transform unit 91 instead of the inverse Fourier transform unit 55 in the first exemplary embodiment shown in FIG. 1. The speech synthesizer of this exemplary embodiment comprises an excited signal generating unit 92 and a vocal-tract articulation equalizing filter 93 instead of the pitch waveform superposing unit 56. The waveform generating unit 4 is connected not to the segment selecting unit 3 but to a segment selecting unit 32. Connected to the segment selecting unit 32 is a segment information storage unit 122. The other components are equivalent to those of the speech synthesizer in the first exemplary embodiment shown in FIG. 1, and thus repeated explanation thereof is omitted for brevity and the same reference characters as in FIG. 1 are assigned thereto.

The segment information storage unit 122 has stored linear prediction analysis parameters (a type of vocal-tract articulation equalizing filter coefficients) as segment information.

The inverse Fourier transform unit 91 generates a time-domain waveform by calculating the inverse Fourier transform of the normalized spectrum outputted by the normalized spectrum loading unit 102. The inverse Fourier transform unit 91 outputs the generated time-domain waveform to the excited signal generating unit 92. Differently from the inverse Fourier transform unit 55 in the first exemplary embodiment shown in FIG. 1, the target of the calculation of the inverse Fourier transform calculation by the inverse Fourier transform unit 91 is a normalized spectrum. The calculation method employed by the inverse Fourier transform unit 91 and the length of the waveform outputted by the inverse Fourier transform unit 91 are equivalent to those of the inverse Fourier transform unit 55.

The excited signal generating unit 92 generates an excited signal of prosody coinciding with or similar to the prosodic information outputted by the prosody generating unit 2 by connecting a plurality of time-domain waveforms outputted by the inverse Fourier transform unit 91 while superposing them. The excited signal generating unit 92 outputs the generated excited signal to the vocal-tract articulation equalizing filter 93. Incidentally, the excited signal generating unit 92 superposes the time-domain waveforms and generates a waveform by the method described in the Reference Literature 8, for example, similarly to the pitch waveform superposing unit 56 shown in FIG. 1.

The vocal-tract articulation equalizing filter 93 outputs a voiced sound waveform to the waveform connecting unit 7 by using the vocal-tract articulation equalizing filter coefficients of the selected segments (outputted by the segment selecting unit 32) as its filter coefficients and the excited signal (outputted by the excited signal generating unit 92) as its filter input signal. In the case where the linear prediction analysis parameters are used as the filter coefficients, the vocal-tract articulation equalizing filter functions as the inverse filter of the linear prediction filter as described in the following Reference Literature 9:

Reference Literature 9: Takashi Yahagi, “Digital Signal Processing and Basic Theories,” Corona Publishing Co., Ltd., 1996, p. 85-100

The waveform connecting unit 7 generates and outputs a synthesized speech waveform by executing a process equivalent to that in the first exemplary embodiment.

The operation of the waveform generating unit 4 of the speech synthesizer in accordance with the second exemplary embodiment will be explained below with reference to figures. FIG. 7 is a flow chart showing the operation of the waveform generating unit 4 of the speech synthesizer in the second exemplary embodiment.

The normalized spectrum loading unit 102 loads a normalized spectrum stored in the normalized spectrum storage unit 101 (step S3-1). Subsequently, the normalized spectrum loading unit 102 outputs the loaded normalized spectrum to the inverse Fourier transform unit 91 (step S3-2).

The inverse Fourier transform unit 91 generates a time-domain waveform by calculating the inverse Fourier transform of the normalized spectrum outputted by the normalized spectrum loading unit 102 (step S3-3). The inverse Fourier transform unit 91 outputs the generated time-domain waveform to the excited signal generating unit 92.

The excited signal generating unit 92 generates an excited signal based on a plurality of time-domain waveforms outputted by the inverse Fourier transform unit 91 (step S3-4).

The vocal-tract articulation equalizing filter 93 outputs a voiced sound waveform to the waveform connecting unit 7 by using the vocal-tract articulation equalizing filter coefficients of the selected segments from the segment selecting unit 32 as its filter coefficients and the excited signal from the excited signal generating unit 92 as its filter input signal (step S3-5).

The waveform connecting unit 7 generates and outputs a synthesized speech waveform by executing a process equivalent to that in the first exemplary embodiment (step S3-6).

The speech synthesizer of this exemplary embodiment generates the excited signal based on the normalized spectra and then generates the synthesized speech waveform based on the voiced sound waveform obtained by the passage (filtering) of the excited signal through the vocal-tract articulation equalizing filter 93. In short, the speech synthesizer generates the synthesized speech by a method different from that employed by the speech synthesizer of the first exemplary embodiment.

According to this exemplary embodiment, the number of calculations necessary at the time of speech synthesis can be reduced similarly to the first exemplary embodiment. Thus, it is possible to reduce the number of calculations necessary at the time of speech synthesis similarly to the first exemplary embodiment even when the synthesized speech is generated by a method different from that employed by the speech synthesizer in the first exemplary embodiment.

Further, since normalized spectra are used for generating the synthesized speech waveforms similarly to the first exemplary embodiment, synthesized speeches of higher sound quality can be generated compared to the case where the periodic components and nonperiodic components of speech segment waveforms are used for generating the synthesized speech as in the device described in the Patent Literature 1.

FIG. 8 is a block diagram showing the principal part of the speech synthesizer in accordance with the present invention. As shown in FIG. 8, the speech synthesizer 200 comprises a voiced sound generating unit 201 (corresponding to the voiced sound generating unit 5 shown in FIG. 1 or 6), an unvoiced sound generating unit 202 (corresponding to the unvoiced sound generating unit 6 shown in FIG. 1 or 6) and a synthesized speech generating unit 203 (corresponding to the waveform connecting unit 7 shown in FIG. 1 or 6). The voiced sound generating unit 201 includes a normalized spectrum storage unit 204 (corresponding to the normalized spectrum storage unit 101 shown in FIG. 1 or 6).

The normalized spectrum storage unit 204 prestores one or more normalized spectra calculated based on a random number series. The voiced sound generating unit 201 generates voiced sound waveforms based on a plurality of segments of voiced sounds corresponding to an inputted text and the normalized spectra stored in the normalized spectrum storage unit 204.

The unvoiced sound generating unit 202 generates unvoiced sound waveforms based on a plurality of segments of unvoiced sounds corresponding to the inputted text. The synthesized speech generating unit 203 generates a synthesized speech based on the voiced sound waveforms generated by the voiced sound generating unit 201 and the unvoiced sound waveforms generated by the unvoiced sound generating unit 202.

With such a configuration, the waveform of the synthesized speech is generated by using the normalized spectra prestored in the normalized spectrum storage unit 204. Thus, the calculation of the normalized spectra can be left out at the time of generating the synthesized speech. Consequently, the number of calculations necessary at the time of speech synthesis can be reduced.

Further, since the speech synthesizer uses the normalized spectra for generating the synthesized speech waveforms, synthesized speeches of higher sound quality can be generated compared to the case where the periodic components and nonperiodic components of speech segment waveforms are used for generating the synthesized speech.

The following speech synthesizers (1)-(5) have also been disclosed in the above exemplary embodiments:

(1) The speech synthesizer wherein the voiced sound generating unit 201 generates a plurality of pitch waveforms based on the normalized spectra stored in the normalized spectrum storage unit 204 and amplitude spectra as segments of voiced sounds corresponding to the text and generates the voiced sound waveform based on the generated pitch waveforms.

(2) The speech synthesizer wherein the voiced sound generating unit 201 generates time-domain waveforms based on the normalized spectra stored in the normalized spectrum storage unit 204, generates an excited signal based on the generated time-domain waveforms and prosody corresponding to the inputted text, and generates the voiced sound waveform based on the generated excited signal.

(3) The speech synthesizer wherein one or more normalized spectra calculated by using a group delay based on a random number series is prestored in the normalized spectrum storage unit 204.

(4) The speech synthesizer wherein the normalized spectrum storage unit 204 prestores two or more normalized spectra. The voiced sound generating unit 201 generates each voiced sound waveform by using a normalized spectrum different from that used for generating the previous voiced sound waveform. With such a configuration, the deterioration in the sound quality of the synthesized speech due to the constant phase component of the normalized spectrum can be prevented.

(5) The speech synthesizer wherein the number of normalized spectra stored in the normalized spectrum storage unit 204 is within a range from 2 to a million.

While the present invention has been described above with reference to the exemplary embodiments and examples, the present invention is not to be restricted to the particular illustrative exemplary embodiments and examples. A variety of modifications understandable to those skilled in the art can be made to the configuration and details of the present invention within the scope of the present invention.

This application claims priority to Japanese Patent Application No. 2010-070378 filed on Mar. 25, 2010, the entire disclosure of which is incorporated herein by reference.

### INDUSTRIAL APPLICABILITY

The present invention is applicable to a wide variety of devices generating synthesized speeches.

### REFERENCE SIGNS LIST

1 language processing unit
2 prosody generating unit
3, 32 segment selecting unit
4 waveform generating unit
5 voiced sound generating unit
6 unvoiced sound generating unit
7 waveform connecting unit
12, 122 segment information storage unit
55, 91 inverse Fourier transform unit
56 pitch waveform superposing unit
92 excited signal generating unit
93 vocal-tract articulation equalizing filter
101 normalized spectrum storage unit
102 normalized spectrum loading unit

1-10. (canceled)

11. A speech synthesizer which generates a synthesized speech of an inputted text, comprising:
a voiced sound generating unit which includes a normalized spectrum storage unit prestoring one or more normalized spectra calculated based on a random number series and generates voiced sound waveforms based on a plurality of segments of voiced sounds corresponding to the text and the normalized spectra stored in the normalized spectrum storage unit;
an unvoiced sound generating unit which generates unvoiced sound waveforms based on a plurality of segments of unvoiced sounds corresponding to the text; and
a synthesized speech generating unit which generates the synthesized speech based on the voiced sound waveforms generated by the voiced sound generating unit and the unvoiced sound waveforms generated by the unvoiced sound generating unit.

12. The speech synthesizer according to claim 11, wherein the voiced sound generating unit generates a plurality of pitch waveforms based on the normalized spectra stored in the normalized spectrum storage unit and amplitude spectra as segments of voiced sounds corresponding to the text and generates the voiced sound waveform based on the generated pitch waveforms.

13. The speech synthesizer according to claim 11, wherein the voiced sound generating unit generates time-domain waveforms based on the normalized spectra stored in the normalized spectrum storage unit, generates an excited signal based on the generated time-domain waveforms and prosody corresponding to the inputted text, and generates the voiced sound waveform based on the generated excited signal.

14. The speech synthesizer according to claim 11, wherein one or more normalized spectra calculated by using a group delay based on a random number series is prestored in the normalized spectrum storage unit.

15. The speech synthesizer according to claim 11, wherein:
the normalized spectrum storage unit prestores two or more normalized spectra, and
the voiced sound generating unit generates each voiced sound waveform by using a normalized spectrum different from that used for generating the previous voiced sound waveform.

16. The speech synthesizer according to claim 11, wherein the number of normalized spectra stored in the normalized spectrum storage unit is within a range from 2 to a million.

17. A speech synthesis method for generating a synthesized speech of an inputted text, comprising:
generating voiced sound waveforms based on a plurality of segments of voiced sounds corresponding to the text and one or more normalized spectra stored in a normalized spectrum storage unit prestoring the normalized spectra calculated based on a random number series;
generating unvoiced sound waveforms based on a plurality of segments of unvoiced sounds corresponding to the text; and
generating the synthesized speech based on the generated voiced sound waveforms and the generated unvoiced sound waveforms.

18. The speech synthesis method according to claim 17, wherein:
generating a plurality of pitch waveforms based on the normalized spectra stored in the normalized spectrum storage unit and amplitude spectra as segments of voiced sounds corresponding to the text, and
generating the voiced sound waveform based on the generated pitch waveforms.

19. A computer readable information recording medium storing a speech synthesis program, when executed,
generating voiced sound waveforms based on a plurality of segments of voiced sounds corresponding to the text and one or more normalized spectra stored in a normalized spectrum storage unit prestoring the normalized spectra calculated based on a random number series;
generating unvoiced sound waveforms based on a plurality of segments of unvoiced sounds corresponding to the text; and
generating the synthesized speech based on generated voiced sound waveforms and generated unvoiced sound waveforms.

20. The computer readable information recording medium according to claim 19, when executed, generating a plurality of pitch waveforms based on the normalized spectra stored in the normalized spectrum storage unit and amplitude spectra as segments of voiced sounds corresponding to the text and generates the voiced sound waveform based on the generated pitch waveforms.
